(19) United States
(12) Patent Application Publication
(10) Pub. No.: US 2012/0025537 A1
(43) Pub. Date: Feb. 2, 2012

(54) WIND TURBINE NACELLE WITH COOLER TOP

(75) Inventors: Krishnamoorthi Sivalingam, Singapore (SG); Anand Bahuguni, Singapore (SG); Ravi Kandasamy, Singapore (SG); Srikanth Narasimalu, Singapore (SG); John K. Grevsen, Viby J (DK); Jesper Nyvad, Ega (DK); Paul T. Tietze, Brabrand (DK)

(73) Assignee: VESTAS WIND SYSTEMS A/S, Randers SV (DK)

(21) Appl. No.: 13/146,528

(22) PCT Filed: Jan. 29, 2010
(86) PCT No.: PCT/DK2010/050023

§ 371 Date: Oct. 24, 2011

Related U.S. Application Data
(60) Provisional application No. 61/148,516, filed on Jan. 30, 2009.

(30) Foreign Application Priority Data
Jan. 30, 2009 (DK) PA 2009 00151

(51) Int. Cl. F03D 9/00

(52) U.S. Cl. 290/55

(57) ABSTRACT

The present invention relates to a wind turbine nacelle comprising a front end facing a wind flow and a rear end arranged downwind from the front end; a first face with a longitudinal extension between the front end and the rear end of the nacelle, the longitudinal extension of the nacelle having a total length; a velocity boundary layer, which is created by the wind flow along the first face from the front end to the rear end, the velocity boundary layer increasing in thickness along the first face and the thickness being lowest at the front end; and a free flow cooling device extending from the first face of the nacelle, the free flow cooling device comprising a cooling area. Furthermore, the cooling area is arranged in relation to the thickness of the velocity boundary layer.

### FIELD OF THE INVENTION

The present invention relates to a wind turbine nacelle having a front end facing a wind flow and a rear end arranged downwind from the front end; a first face with a longitudinal extension between the front end and the rear end of the nacelle, the longitudinal extension of the nacelle having a total length; a velocity boundary layer, which is created by the wind flow along the first face from the front end to the rear end, the velocity boundary layer increasing in thickness along the first face and the thickness being lowest at the front end; and a free flow cooling device extending from the first face of the nacelle, the free flow cooling device comprising a cooling area.

The present invention also relates to a wind turbine.

### BACKGROUND ART

A wind turbine converts wind power into electrical energy by using a generator placed among other equipment in the nacelle of the wind turbine. When the generator converts energy, the walls and the air surrounding the equipment are heated and the equipment itself is thus heated, too.

When the equipment is heated, the efficiency with which the conversion occurs is substantially decreased. In order to cool the equipment, the walls and the air surrounding the equipment are cooled down by means of a heat sink positioned on top of the nacelle as shown in WO 2008/131766 A2. Thus, the cool outside air passes through the heat sink and cools a fluid within the heat sink which is subsequently used to cool the walls or the air surrounding the equipment.

However, such cooling constructions have shown not to be efficient enough to provide an optimal cooling of the walls and the air surrounding the equipment of the wind turbine nacelle.

### SUMMARY OF THE INVENTION

It is an object of the present invention to wholly or partly overcome the above disadvantages and drawbacks of the prior art. More specifically, it is an object to provide an improved wind turbine nacelle which is able to cool the generator and other equipment inside the nacelle more efficiently than the solutions of prior art.

The above objects, together with numerous other objects, advantages, and features, which will become evident from the below description, are accomplished by a solution in accordance with the present invention where the cooling area is arranged in relation to the thickness of the velocity boundary layer.

A more efficient cooling is thus obtained, since the cooling device has been arranged in relation to the height of the velocity boundary layer and thereby the free wind flow. Thus, a larger amount of wind will flow through the cooling device, since a larger cooling area of the cooling device is available for the wind to flow through.

It should be noted that the velocity increases from zero to free stream velocity in the direction away from the first face due to the velocity boundary layer formation. Hence, the mass flow across the cooling area is increased when the cooling device is arranged away from the velocity boundary layer. Also, the thermal performance of the cooling device is increased when it is arranged away from the velocity boundary layer.

In this context, the term “free flow cooling device” is to be understood as a device where no power-driven equipment, such as a fan or the like, is used for leading the wind flow to the cooling device. Furthermore, by using a free flow cooling device, the cooling system of the nacelle becomes more reliable. Also, since the use of fans or the like is avoided, a lower energy consumption is obtained. Since less equipment is arranged on the nacelle, the load on the nacelle has been minimised, and by not using fans or the like a reduction in noise has been observed.

In one embodiment of the invention, the cooling area may be arranged at a rear distance from the rear end of the nacelle and/or at an elevated distance from the first face of the nacelle.

By arranging the cooling device, and thereby the cooling area, either at a rear distance from the rear end of the nacelle or at an elevated distance from the first face, or even both at the same time, a more efficient cooling is obtained. Since the height of the velocity boundary layer is taken into consideration, i.e. by arranging the cooling area in relation to the velocity boundary layer, it is possible to utilise the capacity of the cooling device more effectively, thus making it possible to use a cooling device which has a smaller capacity than those used in the prior art.

Furthermore, the rear distance and/or the elevated distance may be adjustable.

Thus, the cooling area of the cooling device can be adjusted to the instantaneous requirement. It should be noted that the cooling area may be adjusted forward or backward along the first face according to the strength of the wind flow and thus the thickness of the velocity boundary layer. The cooling area may also be adjusted in an elevated distance away from the first face according to the strength of the wind flow and thus the thickness of the velocity boundary layer so that the cooling area is utilised in the best possible way, ensuring an efficient cooling which may be adjusted to the instantaneous requirement in view of the cooling need of the nacelle, the wind conditions, and the temperature.

In an embodiment of the invention, the rear distance may be at least 15% of the total length of the wind turbine nacelle, preferably at least 30% of the total length of the wind turbine nacelle. The rear distance may as well be at least 40% of the total length of the wind turbine nacelle, and also at least 50% of the total length of the wind turbine nacelle.

Tests have shown that the cooling is more even and efficient and that a larger area of the cooling device is being used for cooling when the rear distance is at least 15% of the total length of the wind turbine nacelle, most preferably at least 30% of the total length of the wind turbine nacelle. Also at least 40% of the total length of the wind turbine nacelle, and even at least 50% of the total length of the wind turbine nacelle have shown as advantageous.

Also, the cooling devices used for wind turbines have a considerable weight, and by arranging the cooling device away from the rear end of the nacelle and thereby closer to the centre of gravity of the nacelle, the load on the nacelle and thereby on the tower may be reduced.

When the cooling device is arranged on the first face of the nacelle, the velocity increases from zero to free stream velocity in the vertical direction due to the velocity boundary layer formation. Hence, the mass flow across the cooling area is increased when the cooling device is arranged at an elevated distance from the first face. The thermal performance of the cooling device is increased when it is arranged at an elevated distance from the first face of the nacelle.

Furthermore, at least 30% of the cooling area of the cooling device may be placed above the velocity boundary layer, preferably at least 50% of the cooling area of the cooling device, more preferably at least 75% of the cooling area of the cooling device.

Moreover, the cooling device may extend substantially perpendicular to the first face of the nacelle.

When the cooling device extends substantially perpendicular to the first face of the nacelle, the wind flows towards the cooling device at an angle of approximately 90° to the longitudinal extension of the cooling area, which results in an optimal cooling.

In addition, a part of the first face of the nacelle upwind from the cooling device may be substantially without projections.

Hereby, the wind will not be interrupted during its flow over the first face of the nacelle, and a more efficient cooling is thus obtained.

Furthermore, the nacelle may comprise a cover having at least one inner face, the cooling device being enclosed by the first face of the nacelle and the inner face of the cover.

By enclosing the cooling device within a cover, the wind flow is guided towards the cooling device, resulting in a more efficient cooling as well as a better use of the cooling area of the cooling device.

In one embodiment, the cover may have two side inner faces and an upper inner face, and the cooling device may be enclosed by the first face of the nacelle and the two side inner faces and the upper inner face of the cover.

Thus, the cross-section of the cover is substantially square-shaped, and a standard cooling device may thus be used while still maintaining the distance between the cover and the cooling area.

In addition, the inner face of the cover may extend in the longitudinal extension of the nacelle and substantially perpendicular to the cooling device.

The cover is thus able to guide the wind in a steady flow without changing the wind profile unnecessarily.

Moreover, the cover may have a front edge and the cooling device may be placed at a front distance from the front edge.

In addition, the front distance may be at least 440 mm, preferably at least 600 mm, more preferably at least 800 mm, most preferably at least 1000 mm.

Arranging the cooling device with a front distance of at least 440 mm from the front edge of the cover enables a more efficient cooling, and the capacity of the cooling device is thus used more fully. Furthermore, enclosing the cooling device in the cover and arranging the cooling device at least 440 mm inside the cover, i.e. from the front edge of the cover, creates airflow towards the cooling device, and the capacity of the cooling area of the cooling device is thus also used more fully.

A further advantage of enclosing the cooling device within the cover is thus that the cover may provide the wind turbine nacelle with a recognisable design, which may be used to identify the manufacturer of the wind turbine.

Tests have shown that the cooling is more even and efficient when the front distance is at least 440 mm, and still more even and efficient when the front distance is at least 600 mm, and still more even and efficient when the front distance is at least 800 mm, and still more even and efficient when the distance is at least 1000 mm.

Furthermore, the front distance may be between 600 and 1400 mm, preferably between 1000 and 1100 mm.

Tests have shown that, independent of the height/width ratio of the cooling device, the most even and efficient cooling is obtained when the cooling device is arranged between 600 and 1400 mm from the front edge. The tests have furthermore shown that a front distance between 1000 and 1100 mm is to be preferred independent of the height/width ratio of the cooling device.

In another embodiment, the inner faces of the cover may be substantially without projections. However, in some circumstances, a flange may be arranged on the inside of the cover to strengthen the cover.

Furthermore, the cooling device may be adapted to cool one or more wind turbine components, such as a generator, a transformer, a gear box, a frequency converter, etc.

In one embodiment, the cooling device may comprise a cooling medium adapted to exchange heat with the wind. The cooling medium may be water, oil, air, or another suitable media.

In addition, the first face may be a top face of the nacelle or a side face of the nacelle. In an embodiment, the nacelle may comprise at least a first face, a second face, and a third face, the first face being a top face and the second and third faces being side faces.

In another embodiment, the cover may have a flange projecting in an angle from the inner face, decreasing an opening defined by the first face and the inner face.

Furthermore, the nacelle may comprise a plurality of cooling devices arranged with a mutual distance, wherein the distance between two cooling devices is between 20 and 200 mm, preferably between 50 and 150 mm, and even more preferably between 80 and 120 mm.

Finally, the invention also relates to a wind turbine comprising a wind turbine nacelle as describe above.

### BRIEF DESCRIPTION OF THE DRAWINGS

The invention and its many advantages will be described in more detail below with reference to the accompanying schematic drawings, which for the purpose of illustration show some non-limiting embodiments and in which

FIG. 1 shows a schematic side view of a wind turbine nacelle according to the present invention,

FIG. 2 shows a schematic side view of another embodiment of a nacelle according to the invention,

FIG. 3 shows a schematic side view of yet another embodiment of a nacelle according to the invention,

FIG. 4 shows part of a wind turbine nacelle according to the present invention in a side view,

FIG. 5 shows part of a cross-sectional view of the wind turbine nacelle and the cover,

FIG. 6 shows a side view of part of another embodiment of a wind turbine nacelle according to the invention, and

FIG. 7 shows a schematic back view of an additional embodiment of a wind turbine nacelle according to the invention.

All the figures are highly schematic and not necessarily to scale, and they show only those parts which are necessary in order to elucidate the invention, other parts being omitted or merely suggested.

### DETAILED DESCRIPTION OF THE INVENTION

A wind turbine nacelle 1 is situated on a tower 20 and has a front facing a hub (not shown) in which a plurality of rotor blades (not shown), normally three blades, is fastened. The wind turbine nacelle 1 houses a generator and other equipment used for driving the conversion process of wind energy to electricity—also called the drive train. When producing electricity, the drive train produces a lot of heat, resulting in a less effective conversion process.

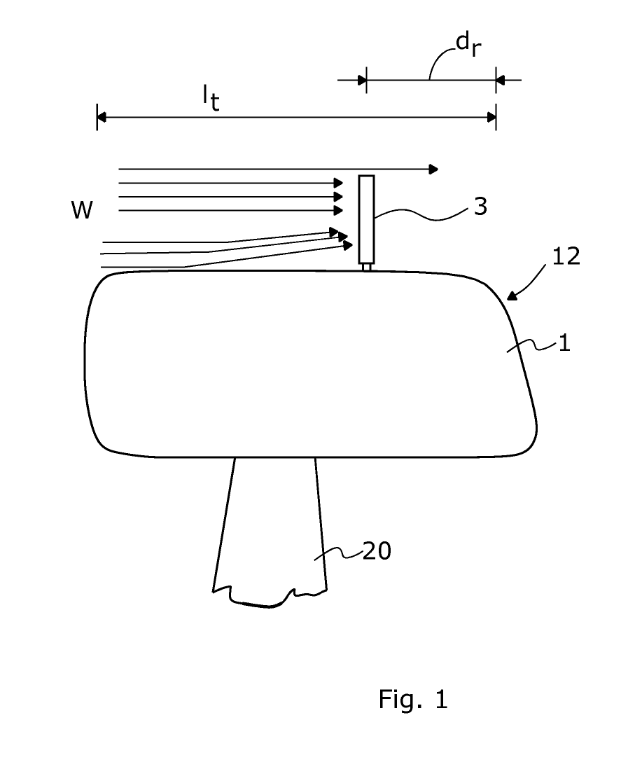

In order to cool the equipment and other parts of the nacelle, a cooling device 3 is arranged outside the nacelle 1. Wind flowing along a longitudinal extension of the nacelle, indicated by the arrows w in FIG. 1, flows in through at least one cooling area 4 of the cooling device 3 and cools a fluid within the cooling device 3. The cooled fluid exchanges heat with the parts of the nacelle 1 or equipment to be cooled.

The present invention will mainly be described in connection with an upwind wind turbine, i.e. a wind turbine where the nacelle is placed downwind from the wind turbine blades. However, the invention may as well advantageously be implemented in a downwind wind turbine, i.e. a wind turbine where the nacelle is placed upwind from the wind turbine blades.

FIG. 1 schematically shows an entire wind turbine nacelle 1. The nacelle 1 has a total length Iₜ, and the cooling device 3 is arranged at a rear distance dᵣ from the rear end 12 of the nacelle 1. According to the inventive idea, the rear distance dᵣ is at least 15% of the total length Iₜ of the wind turbine nacelle 1, measured without the hub.

In other embodiments, the rear distance dᵣ may be at least 30% of the total length Iₜ of the wind turbine nacelle, at least 40% of the total length Iₜ of the wind turbine nacelle, or at least 50% of the total length Iₜ of the wind turbine nacelle.

The arrows w indicate the wind direction and thereby the direction of the flow. When the wind flows along the top face 2 of the nacelle 1, the friction along the top face will force the wind flow upwards and away from the top face, as indicated by the arrows, thus creating the velocity boundary layer. Thus, since the cooling device 3 in this embodiment has been moved forward towards the wind direction on the top face 2 of the nacelle 1, a more efficient cooling is obtained. Also, a larger amount of wind will flow through the cooling device 3 since a larger cooling area 4 of the cooling device is available for the wind to flow through when the cooling area of the cooling device is arranged in view of the thickness of the velocity boundary layer.

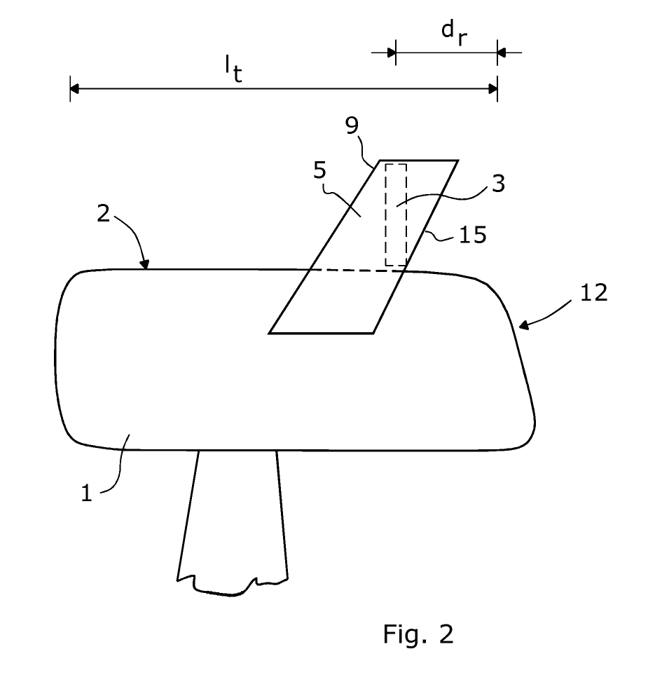

FIG. 2 shows an embodiment of the wind turbine nacelle 1 having a first face 2, in this case the top face of the nacelle, on which a cooling device 3 (indicated by a dotted line) is arranged. The cooling device 3 is surrounded by a cover 5 extending from a top part of the nacelle 1. As can be seen, the cooling device 3 projects substantially perpendicular from the first face 2 of the nacelle 1. However, in another embodiment, the cooling device 3 may extend from the first face 2 of the nacelle in an angle different from 90° in order to provide a more optimal cooling.

As can be seen in FIG. 2, the cover 5 has a front edge 9, which front edge is not perpendicular to the first face 2, but somewhat angled in relation to that. Both the front edge 9 and a back edge 15 are angled in this way. The cover 5 extends from the side of the nacelle 1 and crosses over the first face 2 of the nacelle and is fastened in a similar way on the other side of the nacelle 1. Thus, the cover 5 has a roof part extending substantially parallel to the longitudinal extension of the first face 2 of the nacelle 1.

The cover 5 and thus the inner face 6 of the cover extend in the longitudinal extension of the nacelle 1 and substantially perpendicular to the cooling device 3. However, the cover wall may taper so as to guide the wind into the cooling device 3, or taper from the back edge 15 towards the front edge 9 of the cover.

Again, the cooling device is arranged at a rear distance dᵣ from the rear end 12 of the nacelle. In the shown embodiment, the rear distance dᵣ is approximately 20% of the total length Iₜ of the nacelle 1.

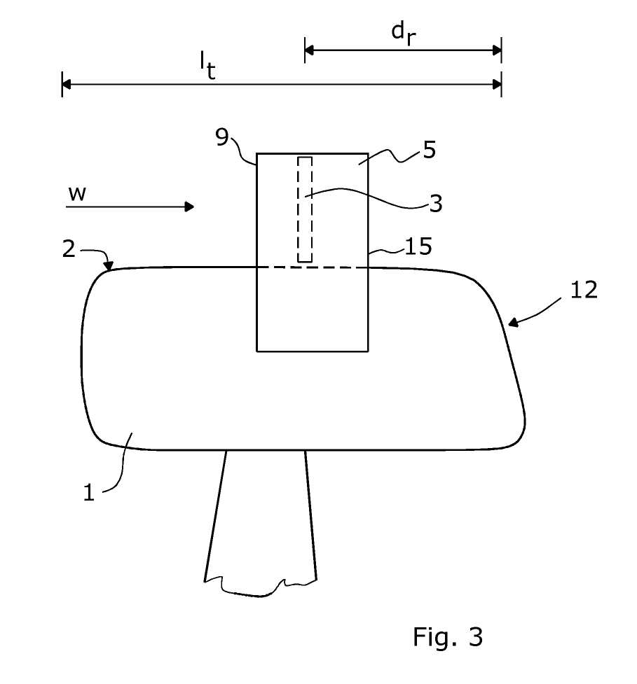

In FIG. 3, another embodiment of the wind turbine nacelle 1 is shown. The cooling device 3 (indicated by a dotted line) is also in this embodiment surrounded and enclosed by a cover 5 extending from the first face 2 of the nacelle 1. The front edge 9 faces the wind direction, indicated by the arrow w, and is in this embodiment substantially perpendicular to the first face 2. The cover 5 also has a back edge 15. The cover 5 and thus the inner face 6 of the cover extend in the longitudinal extension of the nacelle 1 and substantially perpendicular to the cooling device 3.

Accordingly, the cooling device 3 is arranged at a rear distance dᵣ from the rear end 12 of the nacelle. In the embodiment shown in FIG. 3, the rear distance dᵣ is approximately 40% of the total length Iₜ of the nacelle 1.

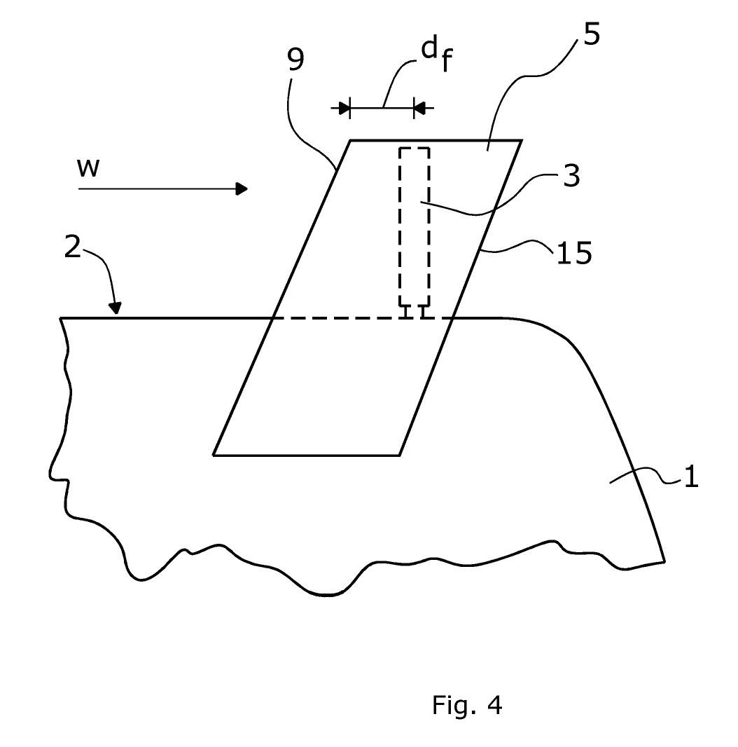

FIG. 4 shows a partial view of the wind turbine nacelle 1 having a first face 2 on which a cooling device 3 (indicated by a dotted line) is arranged. The front edge 9 of the cover 5 faces the wind direction, indicated by the arrow w, and is in this embodiment not perpendicular to the first face 2, but somewhat angled in relation to that. Both the front edge 9 and a back edge 15 are angled in this way. It should be noted that the front edge 9 of the cover 5 slants towards the cooling device 3. In another, not shown, embodiment, the front edge 9 may slant away from the cooling device 3.

In this embodiment, the front distance d_{f} from the slanting front edge 9 of the cover 5 is a shortest distance between the front edge 9 and the cooling device 3. The cooling device 3 has a middle section in the longitudinal extension of the nacelle 1. It is from this middle section that the front distance d_{f} is measured.

The cover 5 is fastened to the side of the wind turbine nacelle 1 and extends perpendicular to the side of the wind turbine nacelle before extending upwards and parallel to the side of the wind turbine nacelle resulting in the creation of a space (not shown) between the side of the nacelle and the inner face 6 of the cover.

By fastening the cover 5 to the side of the wind turbine nacelle, the wind profile of the wind flowing along the first face 2, i.e. the top face, of the nacelle is not changed. Furthermore, the cover 5 is able to cover any elements which do not have the right aesthetic appearance.

In one embodiment, the cover 5 of the wind turbine nacelle 1 may be designed so that the inner face 6 and thus a front part (not shown) of the cover 5 taper towards the cooling device 3. In this embodiment, an outside wall of the cover 5 is kept straight, meaning that the form of the outside wall remains unchanged and that the cover thus still appears a smooth, unbroken surface. In this way, wind is guided in under the cover and through the cooling area.

In another embodiment, the front part (not shown) of the cover 5 also tapers towards the cooling device 3. However, in this embodiment, the wall of the front part of the cover 5 tapers towards the cooling device 3, and the cover 5 is thus able to guide the wind in under the cover and through the cooling area 4.

Wind is guided in under the cover 5 due to the fact the cover, together with the top face 2 of the wind turbine nacelle 1, encloses the cooling device 3.

The cooling device is surrounded by the cover and the top face of the nacelle. However, the cover is open in front of the cooling device in relation to the wind direction. In this way, the wind flowing freely along the top face of the nacelle can also flow freely under the cover. Furthermore, the cover is open at the back of the cooling device so that the wind can flow through the cooling device and out through the back opening of the cover. Thus, there is no cover in front of or behind the cooling device hindering free flow of the wind. The cover only covers the cooling device at its top and sides.

In the embodiments described above, the cover 5 is fastened to the top part of the wind turbine nacelle 1. However, in another embodiment, the cover 5 may be fastened further down the sides of the wind turbine nacelle 1. It may even be fastened near the bottom of the nacelle 1, and may also at least partly enclose the bottom of the wind turbine nacelle.

The rear part 15 of the wind turbine nacelle 1 may have any kind of shape. Thus, it may be round, upwardly or downwardly inclined, or be a vertically straight face so that the end face is perpendicular to the longitudinal extension of the wind turbine nacelle 1.

For the purpose of illustration, the form of the nacelle 1 has merely been sketched. In reality, the nacelle is usually highly aerodynamic in shape and may have rounded corners instead of appearing as a square box. Furthermore, the sides of the nacelle may be concave or convex. The nacelle may even have an overall cylindrical configuration (not shown).

In addition, the first face 2, i.e. the top face and a bottom face of the wind turbine nacelle 1 may taper towards the hub or towards the rear part of the nacelle.

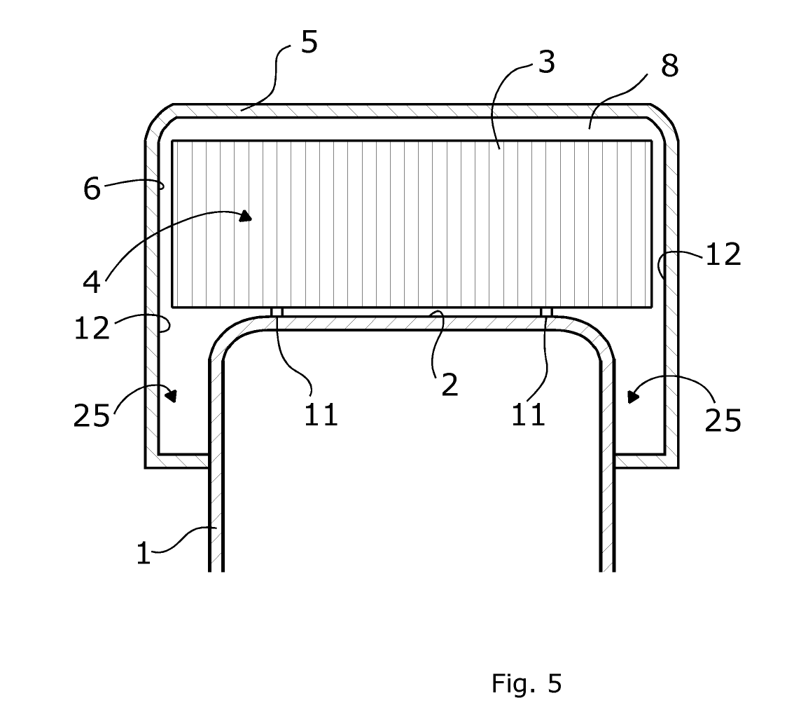

FIG. 5 shows a partly cross-sectional view of the cover 5 and the top part of the wind turbine nacelle 1. The cooling device 3 is arranged on top of the wind turbine nacelle 1 and the fluid for cooling parts of the wind turbine nacelle or the equipment inside runs in tubing in the cooling area 4. The cooling device 3 is connected with the nacelle 1 through two tube connections 11 in which the tubing runs.

The cover 5 of FIG. 5 is fastened to the side of the wind turbine nacelle 1 and extends perpendicular to the side of the wind turbine nacelle before extending upwards and parallel to the side of the wind turbine nacelle resulting in the creation of a space 25 between the side of the nacelle and the inner face 6 of the cover.

By fastening the cover 5 to the side of the nacelle 1, the wind profile of the wind flowing along the first face 2, i.e. the top face, of the wind turbine nacelle remains unchanged. Furthermore, the cover 5 is able to cover elements which do not have the right aesthetic appearance.

Together with the first face 2, the cover 5 encloses the cooling device 3. In this embodiment, the cover 5 has an inner face 6 in the form of two side inner faces 12 and a top inner face. The cooling area 4 is positioned at a distance from the inner face 6. In this embodiment, the distance between the inner face 6 and the cooling area 4 constitutes a gap 8 through which the wind flows, creating turbulence on the back side of the cooling area in order to suck wind in through the cooling area.

The above-mentioned cooling device 3 may be any kind of cooler, heat sink, or heat exchanger where a first fluid, such as the wind, cools a second fluid, such as a coolant, a refrigerant, or the like fluid. In a preferred embodiment, the cooling device 3 is a free flow cooler, i.e. a heat sink through which the wind surrounding the cooling area 4 passes freely and in that way cools the fluid flowing within the tubing of the cooling device.

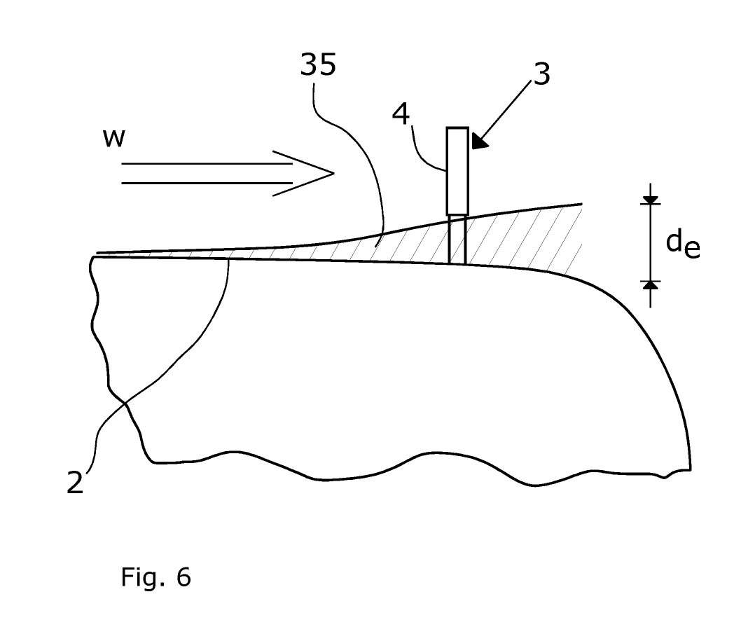

In FIG. 6 the cooling area 4 of the cooling device 3 is arranged at an elevated distance dₑ from the first face 2 of the nacelle 1. The velocity boundary layer 35 is created along the first face of the nacelle 1 and, in this embodiment of the invention, the entire cooling area 4 is arranged above the velocity boundary layer 35. In other embodiments, the cooling device 3 may be positioned near the rear end of the nacelle 1 and with a higher elevated distance from the first face.

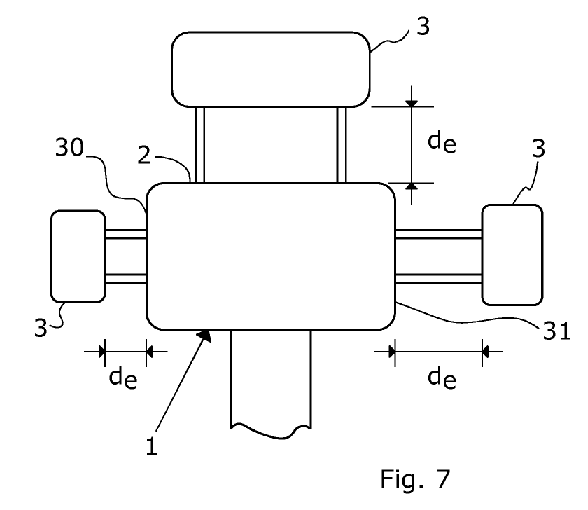

In FIG. 7, a wind turbine nacelle 1 is shown from the back. The nacelle 1 comprises a first face 2, i.e. a top face, and a second 30 and a third 31 face, i.e. side faces. In this embodiment, cooling devices 3 are arranged on all faces 2, 30, 31 of the nacelle 1, all at different elevated distances dₑ from the faces 2, 30, 31 of the nacelle 1.

According to the inventive idea, the cooling device 3 may be adjustably arranged so that it can be adjusted in relation to the velocity boundary layer. The cooling device 3 could for instance be arranged on a frame on which the cooling device can be displaced so that the elevated distance dₑ can be changed. The cooling device 3 could also be arranged on rails on the first face so as to make it movable along the first face in view of the thickness of the velocity boundary layer at a given position on the first face of the nacelle.

The nacelle may also comprise a plurality of cooling devices arranged side by side to form one cooling surface. The cooling devices may be connected to the cooling system as a series or a parallel circuit. One cooling device may be connected to one cooling circuit cooling some elements in the drive train, and another cooling device may be connected to another cooling circuit cooling another section of elements in the drive train. The cooling devices may be connected by means of valves which can fluidly disconnect two cooling devices so that they form part of two separate cooling circuits whereby they can cool separate elements or sections in the nacelle.

The cooling devices may also be arranged with a mutual distance creating a space between them so that wind can flow between two cooling devices in this space. The distance between two cooling devices may be between 20 and 200 mm, preferably between 50 and 150 mm, and even more preferably between 80 and 120 mm.

Within the inventive idea, each cooling device may be separately adjustable in a height/length direction of the nacelle so that if one section, i.e. a component, requires more cooling than other sections/components in the nacelle, the separate cooling device dedicated to cooling this specific section may be either lifted and/or moved in the length direction in view of the boundary layers formation so that the cooling areas of the cooling devices are better explored.

By wind turbine is meant any kind of apparatus able to convert wind power into electricity, such as a wind generator, wind power unit (WPU), or wind energy converter (WEC).

Although the invention has been described in the above in connection with preferred embodiments of the invention, it will be evident for a person skilled in the art that several modifications are conceivable without departing from the invention as defined by the following claims.

1. A Wind turbine nacelle comprising
a front end facing a wind flow and a rear end arranged downwind from the front end,
a first face with a longitudinal extension between the front end and the rear end of the nacelle, the longitudinal extension of the nacelle having a total length,
a velocity boundary layer, which is created by the wind flow along the first face from the front end to the rear end, the velocity boundary layer increasing in thickness along the first face and the thickness being lowest at the front end, and
a free flow cooling device extending from the first face of the nacelle, the free flow cooling device comprising a cooling area, wherein the cooling area is arranged in relation to the thickness of the velocity boundary layer.

2. The wind turbine nacelle according to claim 1, wherein the cooling area is arranged at a rear distance from the rear end of the nacelle and/or at an elevated distance from the first face of the nacelle.

3. The wind turbine nacelle according to claim 2, wherein the rear distance and/or the elevated distance is/are adjustable.

4. The wind turbine nacelle according to claim 1, wherein the rear distance is at least 15% of the total length of the wind turbine nacelle, preferably at least 30% of the total length of the wind turbine nacelle.

5. The wind turbine nacelle according to claim 1, wherein the cooling device extends substantially perpendicular to the first face of the nacelle.

6. The wind turbine nacelle according to claim 1, wherein a part of the first face of the nacelle upwind from the cooling device is substantially without projections.

7. The wind turbine nacelle according to claim 1, wherein the nacelle comprises a cover having at least one inner face, the cooling device being enclosed by the first face of the nacelle and the inner face of the cover.

8. The wind turbine nacelle according to claim 7, wherein the cover has two side inner faces and an upper inner face, the cooling device being enclosed by the first face of the nacelle and the two side inner faces and the upper inner face of the cover.

9. The wind turbine nacelle according to claim 7, wherein the inner face of the cover extends in the longitudinal extension of the nacelle and substantially perpendicular to the cooling device.

10. The wind turbine nacelle according to claim 7, wherein the cover has a front edge and the cooling device is placed at a front distance from the front edge.

11. The wind turbine nacelle according to claim 10, wherein the front distance is at least 440 mm, preferably at least 600 mm, more preferably at least 800 mm, and even more preferably at least 1000 mm.

12. The wind turbine nacelle according to claim 10, wherein the front distance is between 600 and 1400 mm, preferably between 1000 and 1100 mm.

13. The wind turbine nacelle according to claim 1, wherein the cover has a flange projecting in an angle from the inner face, decreasing an opening defined by the first face and the inner face.

14. The wind turbine nacelle according to claim 1, further comprising a plurality of cooling devices arranged with a mutual distance, wherein the distance between two cooling devices is between 20 and 200 mm, preferably between 50 and 150 mm, and even more preferably between 80 and 120 mm.

15. A Wind turbine comprising a wind turbine nacelle according to claim 1.
